(19) United States
(12) Patent Application Publication
(10) Pub. No.: US 2026/0336463 A1
(43) Pub. Date: Oct. 29, 2026

(54) Energy Infrastructures and Method for Reducing Energy Expenditure When Updating Information

(71) Applicant: Bayerische Motoren Werke Aktiengesellschaft, Muenchen (DE)

(72) Inventor: Stefaan DUYM, Muenchen (DE)

(21) Appl. No.: 19/099,166

(22) PCT Filed: May 30, 2023
(86) PCT No.: PCT/EP2023/064351

§ 371 Date: Jan. 28, 2025

(30) Foreign Application Priority Data
Jul. 29, 2022 (DE) 10 2022 119 076.5

(51) Int. Cl. B60L 53/68

(52) U.S. Cl. CPC B60L 53/68

(57) ABSTRACT

A method for reducing energy expenditure in a first transportation vehicle in connection with continuously updating information relating to charging a number of electrically drivable transportation vehicle includes determining a time sequence of files each containing the information, comparing a first file from the sequence of files with a predefined reference, and, depending on the result, forwarding or not forwarding the first file to the first transportation vehicle. An energy infrastructure is also disclosed.

### BACKGROUND AND SUMMARY

The present invention relates to energy infrastructures and a method for reducing energy expenditure in a first transportation vehicle. In particular, the present invention relates to improved handling of information to be continuously updated for an electrically drivable transportation vehicle.

The electrification of personal individual transport is currently progressing rapidly. The supply of the electrically drivable vehicles with electric energy places great demands on the supply grids and energy supply companies. The energy supplier can regulate the consumption to some extent via price incentives in the acquisition of electric energy. For this purpose, for example, it can influence a charging plan of an electric vehicle according to ISO-15118-2. Price tables are sent to the vehicle for this purpose, which are then processed by the vehicle (for example, on the basis of further specifications) to form a charging plan. An optimum charging plan then attempts to charge the vehicle using the correct amount and at the correct times and to generate minimum charging costs in this case. The energy supplier can make a prediction with respect to any possibly occurring energy supply bottlenecks. Nonetheless, it can be necessary to carry out corrections in real time, since the actual current status deviates from the predicted status. For this purpose, the rates available to the user can be changed in real time. For example, in the event of a bottleneck of the available energy, the operator can offer the energy more expensively in order to motivate consumers to acquire less energy. Vice versa, the energy supplier can make the energy less expensive in the event of an excess of electric energy in order to motivate the energy consumption by the user.

The calculation in the motor vehicle presently takes place on control units, which enter sleep mode again after completing calculation of the charging plan. That is to say, the control units involved are to be “woken up” again each time for the processing of new price tables (renegotiation), which has a disadvantageous effect on the service life of these components and on their energetic balance. The number of renegotiation processes accepted by the transportation vehicle is therefore already sometimes restricted. If this limit is reached, the vehicle no longer participates in renegotiations and its user sometimes loses the option of charging at a less expensive rate. Moreover, this has the disadvantage on the side of the energy supplier that the vehicle can no longer be completely addressed via the price negotiation for the participation in the control loop. In other words, the demand can no longer be controlled with complete incorporation of this vehicle.

It is an object of the present invention to satisfy the above-described need.

For this purpose, a method is achieved for reducing energy expenditure in a first transportation vehicle in conjunction with progressive updating of information relating to charging a plurality of electrically drivable transportation vehicles. The method could also be referred to as a method for reducing wear or aging of onboard network components of electrically drivable transportation vehicle in the course of renegotiations for energy supply rates. The electrically drivable transportation vehicle can be, for example, a passenger vehicle, van, truck, motorcycle, aircraft, and/or water vehicle. The information can be, for example, a price table, a table with respect to electrical characteristic variables of the supply grid, or other information, on the basis of which the transportation vehicle makes decisions about the time at which it acquires which amount of electrical energy from the grid or feeds it back into the grid. The progressive updating can in particular take place in cycles of seconds, cycles of minutes, or cycles of hours. The updating is typically not continuous, however, but rather is performed by individual messages or files transmitted from the energy supplier to the controllable consumer. The plurality of electrically drivable transportation vehicles can be distributed over a road, a neighborhood, a city, a state, a country, or multiple countries. In a first step, a chronological sequence of files each containing the information is ascertained. This can take place in a server or on a computer of an energy supplier. The chronological sequence of files represents different updating stages of otherwise preferably identical files. For example, they can characterize a price per kilowatt hour, a rated voltage of an energy supply grid, a frequency of an energy supply grid, a frequency stability of an energy supply grid, or the like. The chronological sequence of files thus outputs essentially identical parameters having different (time) values to the plurality of electrically drivable transportation vehicles. The transportation vehicles can be all transportation vehicles which can process the information. In other words, the information can in principle be received, interpreted, and used to design a charging plan by all electrically drivable transportation vehicles. According to the invention, however, not every file is received, checked, and processed at every time by every vehicle. For this purpose, a first file from the sequence of files is compared to a predefined reference. The predefined reference can be stored, for example, on the same server where the chronological sequence of files has been ascertained or prepared and can be compared to the first file. Alternatively or additionally, the predefined reference can also be stored on a wall box of a user of a first electrically drivable transportation vehicle and used for comparison to the first file. Of course, the predefined reference can also be stored on another computer, in particular between the server of the energy supply company and the wall box (also: “charging station”) and kept in reserve for the comparison to the first file. Depending on a result of the comparison, the first file is then forwarded or not forwarded to the first transportation vehicle. In other words, depending on the comparison result, the vehicle is supplied with the first file or the information contained therein or is just not bothered by the first file. In the latter case, the electronic control unit responsible for the preparation of the charging plan is not woken, due to which no corresponding wear, no corresponding heat development, and no corresponding energy expenditure occur. Only for the case that the predefined reference specifies the forwarding to the first transportation vehicle (or a control unit, in particular a media graphic unit (MGU), thus a main graphics processor, or a body control processor (BCP)), the first transportation vehicle can be woken and the content of the first file can be taken into consideration in the preparation of the charging plan. The progressively updated information can therefore be taken into consideration appropriately for the situation and the disadvantages known in the prior art can be alleviated.

The present disclosure discloses preferred refinements of the invention.

In the predefined reference, for example, a minimum difference of information between the first file and a file ascertained at an earlier time from the sequence of files can be defined in order to recognize a sufficient relevance of the first file and forward the first file to the first transportation vehicle. In particular for the case that the information contained in the first file and the file ascertained at an earlier time are (nearly) identical, a check of the charging plan in the transportation vehicle can appear obsolete and the energy expenditure and the waste heat and wear can be spared.

For example, the predefined reference can identify the first transportation vehicle as belonging to a first group in order to ascertain the relevance of the first file for the first transportation vehicle. The first group can be defined, for example, on the basis of a vehicle identification number and/or on the basis of a geographic position and/or on the basis of a trademark and/or on the basis of further circumstances which appear suitable for partitioning the entire plurality of electrically drivable transportation vehicles which is to be supplied by the progressive updates of information. The energy supplier or the server can therefore define which of the defined groups are primarily to be addressed by the first file. Vice versa, the server or the energy supplier can in this way define which of the groups has a lower relevance for the current first file. In this way, the updating of charging plans can be made more suitable for demand or more effective.

For example, the different groups of electrically drivable vehicles can be assigned different time cycles, according to which the files are delivered or the information to be updated is updated. This can also take into consideration how much energy or expenditure a recalculation of a charging plan for the vehicles of the respective group has. A group which contains transportation vehicles having a high computing efficiency can be stopped for recalculation more frequently, for which purpose the cycling rate can be increased. Vehicles of a group which have a lower computing efficiency can be addressed by the files with lower cycling rate. A high cycling rate can mean, for example, that the transportation vehicle receives every second, every third, every fourth, or every fifth file/update, while a low cycling rate can mean that the transportation vehicle receives and has to evaluate every sixth, every seventh, every eight, every ninth, or every tenth file.

In particular for the case that the energy supplier has to handle an energy access or a supply bottleneck in a geographically (narrowly) bounded region, the predefined reference can characterize the first group in relation to a second group as associated with a geographic position or a predefined geographic region. The groups can therefore be formed dynamically, depending on where the individual vehicles participating in the method are currently located. This can be established, for example, using satellite-based positioning systems. The above-mentioned file to be received by the transportation vehicle can in particular be configured to wake a control unit of the transportation vehicle. In other words, the control unit is not woken (or the transportation vehicle is woken for another reason) if the file is not received. In response to the evaluation of the file, the control unit is in turn configured to execute charging processes in modified form or execute them at a changed time.

The information in the first file relates to charging of the transportation vehicle in that an availability or other characteristic variables (voltage, frequency, frequency stability, voltage stability, maximum charging current, etc.) for charging electrical energy are represented. In particular, a price per kilowatt hour can also be defined by the first file. In other words, a current purchase price, but in particular also a future purchase price for the kilowatt hour of electric energy is represented in the file. On this basis, the transportation vehicle can predefine current or future charging processes in order to charge efficiently and cost-effectively and, on the other hand, ensure the best possible mobility or availability of the transportation vehicle.

According to a second aspect of the present invention, an energy infrastructure (a server) for reducing energy expenditure in a first transportation vehicle in conjunction with progressive updating of information relating to charging a plurality of electrical transportation vehicles is proposed. The energy infrastructure comprises a server, which has a data input and a data output. In this way, the server is configured to ascertain a first chronological sequence of files containing the information, and to transmit these files to a first plurality of electrically drivable transportation vehicles addressed by the information. So as not to wake up all transportation vehicles which are fundamentally attended to by the server and therefore promote energy, waste heat, and wear, a first file from the sequence of files is compared to a predefined reference by the server. Depending on the result, the first file is forwarded or not forwarded to the first transportation vehicle. In other words, the method according to the invention is preferably exclusively carried out on a single server on which all information required for this purpose is present. The features, combinations of features, and the advantages resulting therefrom of the energy infrastructure according to the invention obviously correspond to those which have already been listed above in conjunction with the method according to the invention in such a way that reference is made to the above statements to avoid repetitions.

According to a third aspect of the present invention, a (second) energy infrastructure for reducing energy expenditure in a first transportation vehicle in connection with progressive updating of information relating to charging a plurality of electrical transportation vehicles is proposed. The infrastructure has a server having a data input and a data output as well as a wall box having a data input and a data output. The server is configured to ascertain a first chronological sequence of files containing the information and transmit them (in particular all of them) to the wall box. The wall box is in turn configured to compare a first file from the sequence of files to a predefined reference and to forward or not to forward the first file to the first transportation vehicle (which is in particular connected thereto with respect to information and/or traction energy) depending on the result. In other words, in this case the wall box decides about which files are suitable for the transportation vehicle or at least so promising with respect to their content that it pays to wake up the first transportation vehicle or its control unit to update a charging plan. Reference is also made to the above statements for the advantages, features, and combinations of features with respect to the second infrastructure in order to avoid repetitions.

According to a core concept of the present invention, it is proposed that new price tables be compared with preceding versions in a component upstream of the transportation vehicle and if differences are excessively small, that a renegotiation be prevented in order to spare energetic and computing expenditures required for this purpose in the transportation vehicle. Additionally or alternatively, the addressed vehicles can be partitioned into strategically or geographically divided groups, wherein each individual group is applied using a cycle which is lower than the main cycle in which the price tables are fundamentally generated. Therefore, each transportation vehicle does not receive each file. The energy supplier, however, can decide via the adaptation of the cycling (main cycling) how important a wide-ranging update of the charging plans is presently. One example will be described hereinafter for illustration.

An energy operator has to react in a highly dynamic manner in real time to variations in the grid. For this purpose, he uses a control loop having a cycling rate of 5 minutes, wherein he adapts the prices for his customers. For this purpose, he divides his customer base into 20 groups, equally geographically distributed.

He now communicates a first binding change of the price table to group 1 on the basis of his real time regulation.

He communicates a first binding change of the price table to group 2 5 minutes later on the basis of his real time regulation.

He communicates a first binding change of the price table to group 3 10 minutes later on the basis of his real time regulation.

He communicates a first binding change of the price table to group i (i−1)*5 minutes later on the basis of his real time regulation.

He communicates a first binding change of the price table to group 20 95 minutes later on the basis of his real time regulation.

This slower loop then repeats again with the first group:

He communicates a second binding change of the price table to group 1 100 minutes later on the basis of his real time regulation. He communicates a second binding change of the price table to group 2 105 minutes later on the basis of his real time regulation.

He communicates a second binding change of the price table to group i 100+(i−1)*5 minutes later on the basis of his real time regulation.

The entire ecosystem hereby reacts with a cycle of 5 minutes to fluctuations in the energy supply, but the individual customer is only addressed every 100 minutes and his vehicle also only has to wake up at most every 100 minutes, which has a more favorable effect on the service life of the components.

Further details, features, and advantages of the invention result from the following description and the figures.

### BRIEF DESCRIPTION OF THE DRAWINGS

FIG. 1 shows a schematic representation of a scenario in which an energy infrastructure according to the present disclosure supplies a plurality of electrically drivable transportation vehicles with progressive updating of information about network conditions; and

FIG. 2 shows a flow chart illustrating steps of an exemplary embodiment of the method according to the present disclosure for reducing energy expenditure in a first transportation vehicle in connection with progressive updating of information relating to charging a plurality of electrically drivable transportation vehicles.

### DETAILED DESCRIPTION OF THE DRAWINGS

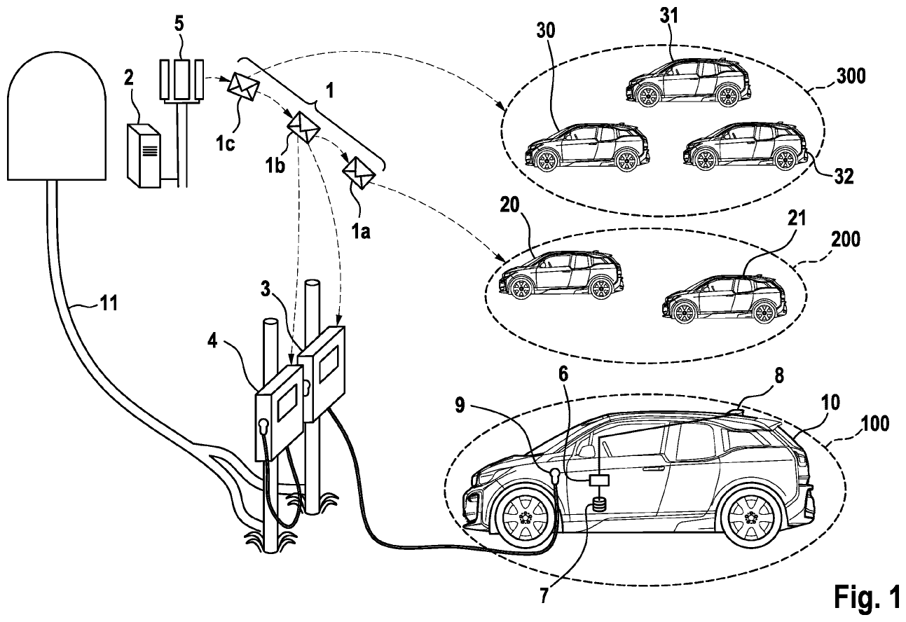

FIG. 1 shows a plurality of electrically drivable transportation vehicles 10, 20, 21, 30, 31, 32, which are divided into geographic groups 100, 200, 300. The first transportation vehicle 10 has a data memory 7, an electronic control unit 6 connected thereto with respect to information, and an antenna 8 and charging socket 9. A charging plug 9 of a wall box 3 is plugged into a charging socket to supply the group 100. The wall box 4 is presently not in use. A server 2 of an energy supply company calculates current and future rates for the wall boxes 3, 4. The results of the calculation are essentially tables with respect to the conditions under which the transportation vehicles 10 to 32 can purchase from the energy supply network 11. The server 2 transmits a chronological sequence 1 of files 1a, 1b, 1c via a transmission mass 5 to the groups 100, 200, 300 or the wall boxes 3, 4. The parameters in the files 1a, 1b, 1c are each the same, while their values are oldest in the file la and are most up-to-date in the file 1c. In order not to have to wake up the electrically drivable transportation vehicles 10 to 32 in the illustrated basic cycling of the sequence 1 of files and have to bother them with the recalculation of the respective charging plans, the file 1a is transmitted to the group 200, the file 1b is transmitted to the wall boxes 3, 4, and the file 1c is transmitted to the group 300. In other words, only the members of the respective group 100, 200, 300 each receive identical updates of information. Of course, the energy supplier can take influence on which file 1a, 1b, 1c is sent to which group 100, 200, 300. In this way, it is possible to react locally to local energy excesses or bottlenecks, if the groups 100, 200, 300 are local definitions of groups.

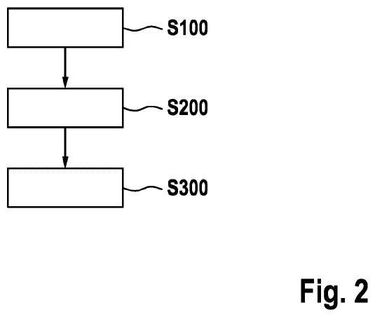

FIG. 2 shows steps of a method according to the present disclosure for reducing energy expenditure in a first transportation vehicle in connection with progressive updating of charging information. In step S100, a chronological sequence of files is ascertained by a server of an energy supply company, wherein the files contain the charging information (prices, grid characteristic variables, and future parameters and price models). All files of the chronological sequence have a similar or even identical structure, wherein in particular they differ exclusively due to the values of the respective identical parameters. In step S200, a first file from the sequence of files is compared to a predefined reference. This can take place on the server or a computer located between the energy supply server and the transportation vehicle or another evaluation unit. Depending on a result of the comparison, in step S300, the first file is forwarded or not forwarded to the first transportation vehicle. Therefore, only files currently suitable for the first transportation vehicle due to the reference reach the transportation vehicle, which is preserved from unnecessary recalculations of the charging plans and expenditures connected thereto with respect to energy and computing power.

This mechanism can also be used locally at a location if multiple electrical consumers are in competition with one another there due to a house connection limited in performance, in particular in multifamily houses where multiple electrical vehicles are charged simultaneously, for example. A home energy management system would have to handle an energy distribution here.

Other examples are fleet management for industrial customers (for example, charging in a parking garage) as soon as power limits (of the energy supplier infrastructure (for example, lines, transformers)) are reached.

### LIST OF REFERENCE SIGNS

1 chronological sequence
1a, 1b, 1c files
2 server
3, 4 wall box
5 transmission mass
6 evaluation unit (electronic control unit)
7 data memory
8 antenna
9 charging plug
10 electrically drivable transportation vehicle
11 energy supply grid
20, 21, 30, 31, 32 electrically drivable transportation vehicles
100-300 groups
S100-S300 method steps

1.-12. (canceled)

13. A method for reducing energy expenditure in a first transportation vehicle in connection with progressive updating of information relating to charging a plurality of electrically drivable transportation vehicles, the method comprising:
ascertaining a chronological sequence of files each containing the information;
comparing a first file from the sequence of files to a predefined reference; and
forwarding the first file to the first transportation vehicle depending on a result of the comparing.

14. The method according to claim 13,
wherein the predefined reference represents a minimum difference of information between the first file and a file ascertained at an earlier time of the sequence of files.

15. The method according to claim 13,
wherein the predefined reference identifies the first transportation vehicle as associated with a first group that is not addressed by the first file, or as associated with a second group that is addressed by the first file.

16. The method according to claim 15,
wherein the first group is associated with a first chronological cycling rate, and the second group is associated with a second chronological cycling rate, different from the first chronological cycling rate, for the addressing by the files of the sequence of files.

17. The method according to claim 15,
wherein the predefined reference identifies the first group as associated with a geographic position or geographic region.

18. The method according to claim 15, wherein the first group and/or second group is addressed by the files according to a respective cycle, which is lower than a basic cycle by use of which the chronological sequence is ascertained.

19. The method according to claim 13, wherein the forwarding is carried out by a server and/or a wall box and/or a home energy management controller and/or a smart meter.

20. The method according to claim 13, wherein the first file is configured to wake a control unit upon reception by the transportation vehicle.

21. The method according to claim 13, wherein the information relating to charging of the plurality of transportation vehicles represents an availability or other characteristic variables for charging electrical energy.

22. An energy infrastructure for reducing energy expenditure in a first transportation vehicle in connection with progressive updating of information relating to charging a plurality of electrical transportation vehicles comprising:
a server having a data input and a data output, wherein the server is configured to:
ascertain a first chronological sequence of files containing the information;
compare a first file from the first chronological sequence of files to a predefined reference; and
forward the first file to the first transportation vehicle depending on a result of the comparison.

23. An energy infrastructure for reducing energy expenditure in a first transportation vehicle in connection with progressive updating of information relating to charging a plurality of electrical transportation vehicles comprising:
a server having a data input and a data output; and
a wall box having a data input and a data output,
wherein the server is configured to:
ascertain a first chronological sequence of files containing the information and transmit it to the wall box; and
wherein the wall box is configured to:
compare a first file from the first chronological sequence of files to a predefined reference; and
forward the first file to the first transportation vehicle depending on a result of the comparison.
